(19) United States
(12) Patent Application Publication
(10) Pub. No.: US 2008/0073160 A1
(43) Pub. Date: Mar. 27, 2008

(54) Sensor detecting wear in a brake lining of a vehicular brake system

(75) Inventor: Daniel Dobler, Feldkirch (AT)

Correspondence Address: K.F. ROSS P.C., 5683 RIVERDALE AVENUE, SUITE 203 BOX 900, BRONX, NY, 10471-0900, US

(73) Assignee: Hirschmann Automotive GmbH

(21) Appl. No.: 11/901,728

(22) Filed: Sep. 18, 2007

(30) Foreign Application Priority Data
Sep. 22, 2006 (DE) 102006044909.6

(51) Int. Cl. F16D 66/02

(52) U.S. Cl. 188/1.11 L

(57) ABSTRACT

The invention relates to a sensor for detecting wear of a brake lining of a vehicular brake system, the sensor being imbedded in the brake lining and worn off by the brake disk (3) of the brake system, where according to the invention a block (2) of predetermined size of resistance material is mounted between two spaced electrically conductive sensors (1), the block (2) being electrically connected to the supports (1).

The invention relates to a sensor for detecting wear of a brake lining of a brake system of a vehicle, where a sensor built into the brake lining is abraded by a brake disk in the brake system, according to the characteristics of patent claim 1.

Such a sensor is known for example from DE 10 2005 009 123.7 [US 2006/0219487]. It essentially consists of a punched screen on which resistors are mounted to form a circuit, with the entire formation (punched screen with resistors and connected lines) being encased in a casing. The casing in this embodiment is manufactured in a plastic injection-molding procedure. The finished sensor is installed at the proper position into the brake system of the vehicle and, during operation of the vehicle, is abraded by the brake disk, or rather by the pressing of the brake lining onto the brake disk, so that the punched screen forming a circuit is ground off and at least one circuit is broken, resulting in an sudden change in resistance that can be detected by a downstream electronic analysis system. This sudden change in resistance is displayed to the operator (driver) of the vehicle to show that the wear of the brake lining has reached such a degree that it will be necessary to replace the brake lining within a certain time period in order to ensure the proper functioning of the vehicular brake system.

A brake lining wear sensor of this type known from the prior art has however several disadvantages. First, after the manufacture of the punched screen it is very costly to mount the resistors on this punched screen and to connect them up electrically. A further disadvantage is that the plastic injection-molding method for manufacturing the casing must be carried out at very high temperatures, which can have a harmful effect on the resistors and/or their points of contact with the punched screen. In addition, very high temperatures are present when the brake lining is pressed against the brake disk during the operation of the brake system in the vehicle, so that the same problems arise in this case as in the manufacture of the casing using the plastic injection-molding method. In addition, only discontinuous (suddenly changing) output signals can be generated, not continuous output signals.

The object of the invention, therefore, is to provide an improved sensor for detecting wear in a brake lining of a brake system of a vehicle.

This object is attained by the characteristics of patent claim 1.

According to the invention, it is envisioned that at least one block of predetermined size (volume), made of a resistance material, is positioned between two spaced-apart supports for the contact (outward conveyance of the output signal), consisting of an electrically conductive material and positioned to the sides, with the block being connected to and contacted in an electrically conductive manner to the supports.

Voltage is applied across (or a current is supplied to), the two supports that form an electrical connection (contact), so that together with the block made of resistance material they form a resistor. Meanwhile, the two supports and the block are mechanically connected and, in an electrically conductive manner, connected to one another, while the connection and the contact can be accomplished in two distinct process steps or in a single joint process step. This process can be, for example, a welding process or a soldering process, and also the application of a resistance layer (forming the support) to the block can be done by adhesion of the supports to the block or else a direct spraying of the supports onto the block (or vice-versa). It is especially advantageous if the block and/or the supports are made out of a injection-molded filled and electrically conductive plastic, since the elements involved (block and supports) can be manufactured, contacted to one another and electrically interconnected in a single operation.

The block between the supports, as a functional layer, forms, via the linkage of the support material, a resistor that changes with the change in volume or geometric dimension caused by impact with the brake disk when the brake lining presses against it and is abraded. The change in resistance can be analyzed to generate a measurement signal.

The block made of resistance material in a predetermined size enables a continuous measurement of brake-lining wear through the change in geometric dimension, which must be adjusted within the brake system to fit the application. That means that with increasing abrasion of the brake lining, at least the block of predetermined size made of resistance material is also abraded further, while, in contrast to sensors for detection of brake lining wear known from prior art, a continuous output signal can be obtained as an analog measure of the brake lining wear. This output signal, that is, the measurement value obtained, need not be linear, but rather can be adapted case by case to the requirements for measurement of brake-lining wear. Thus, for example, through the shape of the block, a linear, exponential or even a specific curve shape is feasible. For example, with a cubic or rectangular block that is abraded in the lengthwise direction, a linear output signal can be obtained as a measure of brake-lining wear, since with increasing abrasion of the block, the resistance changes linearly and this change in resistance can likewise be displayed linearly. With other geometric shapes of the block, a different curve shape can be obtained, preferably an exponential curve shape, even when the brake lining (abrasion) impacts the block in the direction of abrasion. That means that the invention offers the possibility of manufacturing a block of predetermined size and positioning it between the two supports (contact), while based on the dimensions of the block, its volume and its material, a starting value of resistance is created that represents a starting measurement for the thickness of the brake lining. With increasing abrasion of the brake lining, every time it is used there is abrasion of the block and thus a change in the resistance level. This makes it possible not only to obtain discontinuous output signals, representing a measurement beyond which it would appear necessary to replace the brake lining, but rather continuous output signals (such as linearly rising, linearly falling, exponentially rising, exponentially declining and other curve shapes) could be generated, each representing a measurement for the abrasion of the brake lining and each being analyzable using a downstream electronic analysis system on the basis of a software application stored therein. In summary, this means that, the invention, with the help of a block made of a resistance material of predetermined size and predetermined resistance properties (particularly the value of resistance), can generate a continuous output signal that, depending on the change in geometry (particularly the volume) of the block by abrasion of the brake lining creates a measurement of the wear of the brake lining, this output signal being able to be specified by the geometry of the block and analyzed.

To obtain a defined starting output signal (before the installation of the sensor into the brake system), a defined value of resistance can be established by a precise setting of the volume or the geometric dimensions of the sensor. It must be remembered, meanwhile, that this precise value is already set when the sensor is manufactured (e.g. in an injection-molding method as mentioned above), or the manufactured sensor is set by exerting influence, for example by means of vaporizing, punching away, lasering away or the like performed on the block positioned between the supports. This has the advantage, moreover, that a sensor manufactured according to a single standard can be modified even for brake linings of different thicknesses.

In general, the sensor according to the invention offers a high degree of temperature stability, since the materials used for the supports and block are made out of correspondingly temperature-stable materials. In addition, the sensor has a simple structure and can be realized cost-efficiently, especially when the sensor is manufactured by a plastic injection molding. By coordinating the shape of the sensor and the materials, any desired output signal can be generated. If only one block is present between the supports, a linear output signal can be generated, for example, that represents the continuous wear of the brake lining. A further advantage can be seen in the fact that the inventive sensor can be used in place of sensors known in the prior art, since its outer shape does not change, or rather its outer shape can be matched to that of the existing sensors. This is the case especially when the sensor, in an advantageous manner, has a casing that encases the supports and the block and is made of a heat-resistant material. Thus the outer shape of the casing can match the outer shape of sensor casings known in the prior art. Alternatively, it is conceivable that the sensor would have a casing layer that laterally encases the supports and is made of a heat-resistant material. This way the entire sensor need not be encapsulated in a casing, but rather only those places on the supports by means of which the sensor is installed in the brake system. Since in the normal case the sensor is fastened to a caliper and this caliper is made of a flat material in brake systems known in the prior art, it can thus advantageously be conceived that the supports would have the casing layer on the sides, with the outer contours of the casing layer matching up with a recess in the caliper in which the sensor is positioned.

In a further development of the invention wiring is connected to both supports, or that each support has a contact surface for connection to another contact that is connected to the end of a wire. The simplest case is the connection of a cable to the support, with the electric conductor of the cable being fastened to the support at an appropriate position using an appropriate method and electrically contacted to it. This attachment method may, for example, be a soldering or welding procedure, although other methods by which the conductor can be fastened and electrically contacted to the support are also possible. As an alternative, the support has a contact surface (e.g. in the form of a coating dot) or forms the contact surface itself. That makes it possible to electrically contact the support to a another contact mounted at the end of a wire. Meanwhile, it must be remembered, however, that this connection via the contact surface on the support and the counter-contact surface on the end of the wire must be suited to the prevailing environmental conditions in the vicinity of the brake system (high temperatures, vibrations, shocks, moisture and splash water, chemical impacts, for example from deicing salt, and the like).

In a further development of the invention, at least two blocks are provided between the supports, arranged one after another in the direction of wear, with the blocks electrically insulated from one another. By means of the two blocks positioned between the supports, a sensor is formed that can generate a two-step signal (or that can generate a multi-step signal if multiple blocks are present). For example, when the first block to be abraded by the brake disk is fully worn away, this can be analyzed and a signal can be displayed to the driver of the vehicle that within a certain time period or within a certain driving distance the brake disks ought to be replaced. Once the second block is likewise abraded, it can again be signaled to the driver that it is now absolutely necessary to replace the brake lining. In case of a two-step or multi-step sensor, either the resistance that is formed from each block between the supports can be analyzed, or instead an analysis of any current flow at all is still possible between the supports (if the respective block is not yet completely abraded) or no current flow is present anymore (namely when the respective block is completely abraded).

Embodiments of the invention are described in the following and illustrated using the figures. However, the invention is not limited to these embodiments.

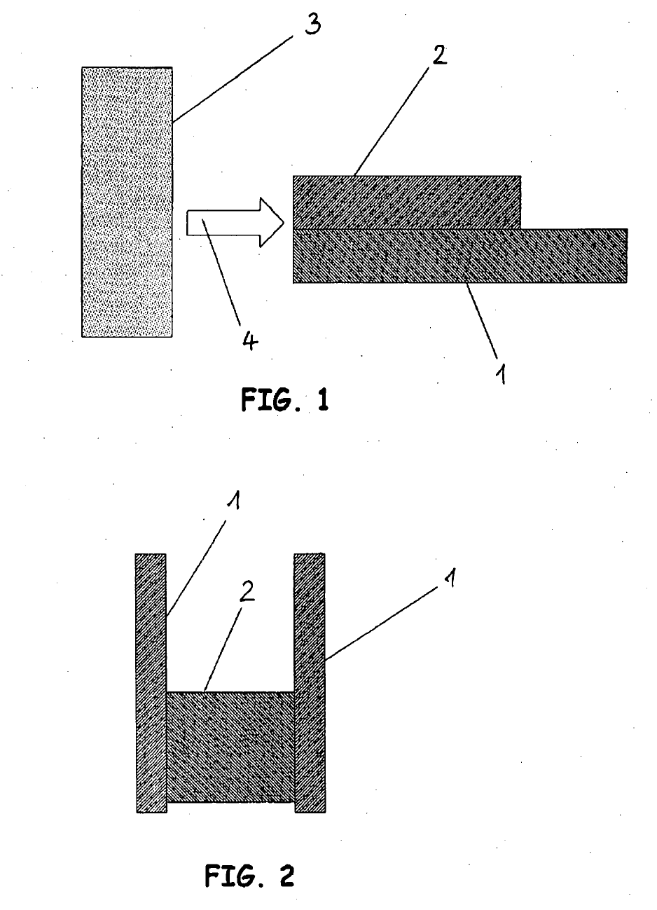

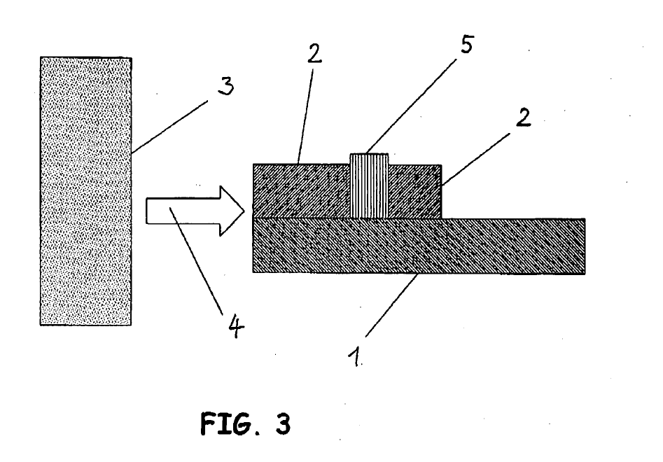

FIGS. 1 and 2 show sectional views of a single-step sensor,

FIG. 3 shows the basic structure of a multi-step sensor.

FIG. 1 shows two supports 1 between which a block 2 is positioned as a functional layer made of a resistance material. The block 2 is suitably connected to and contacted in an electrically conductive manner to the supports 1. Not shown, but present, is the connection of a wire to each support 1 in order to enable detection of a change in resistance by an unillustrated downstream electronic analysis system when the block 2 (together with the supports 1) is abraded. Wearing away of the sensor occurs by engagement with a moving brake disk 3 of a vehicle brake system not shown in detail in the direction of arrow 4. The geometric shapes of supports 1, block 2 and brake disk 3 in FIGS. 1 and 2 are only given as examples, and can be adapted to fit the geometric conditions of a vehicular brake system.

FIG. 3 shows a two-step sensor; meanwhile, it can be seen that two blocks 2 are positioned one after another in the wear direction 4 between the supports 1, these two blocks 2 being separated from one another by an insulating layer 5. This forms a two-step sensor; meanwhile, more than two blocks can also be arranged one after another and separated by an insulating layer, in order to realize a multi-step sensor, if desired. In this case, too, the depiction in FIG. 3 is only explanatory and the shaped blocks 2 can be adapted to fit the respective geometric conditions of the brake system and the output signals to be generated. The two blocks 2 of FIG. 3 are structured analogously to the block 2 shown in FIG. 1. In particular, they can be made of the same and/or different material and have the same or different dimensions (or the same or different volumes as a result).

1. A sensor for detecting wear of a brake lining of a vehicular brake system, the sensor being recessed in the brake lining and worn off by the brake disk of the brake system wherein a block of predetermined size of resistance material is mounted between two spaced electrically conductive supports, the block being electrically connected to the supports.

2. The sensor according to claim 1 wherein the sensor has a casing of heat-resistant material that surrounds the block and the supports.

3. The sensor according to claim 1 wherein the sensor has a casing layer of heat-resistant material laterally surrounding the supports.

4. The sensor according to claim 1, wherein the a wire is connected to the support 1.

5. The sensor according to claim 3 wherein the support has a contact face for connection with another contact that is on the end of the wire.

6. The sensor according to claim 1 wherein the block and/or the support is made of an injection-molded and electrically conductive filled plastic.

7. The sensor according to claim 1 wherein in a wear direction there are at least two of the blocks between the supports, the blocks being electrically separated from each other by a barrier layer.

8. In combination with a brake lining and a movable brake element engageable therewith, a sensor comprising:
a block of resistive material recessed in the lining and engageable with the brake element, whereby the block wears away with the lining;
a pair of spaced electrically conductive supports connected at spaced locations to the block; and
control means connected to the supports for monitoring a resistance of the block.

9. The sensor defined in claim 8, further comprising
an abradable casing surrounding the block and the supports.

10. The sensor defined in claim 9 wherein the casing is made of a heat-resistant plastic.

11. The sensor defined in claim 9 wherein the block and supports are imbedded in the casing.

12. The sensor defined in claim 8, further comprising
respective wires connected between the support and the control means.

13. The sensor defined in claim 8 wherein the block is worn away in a predetermined direction by contact with the element, the supports being spaced apart transversely of the direction.

14. The sensor defined in claim 13, further comprising
a second such block between the supports and immediately adjacent the first-mentioned block; and
an insulating layer between the first and second blocks.

15. The sensor defined in claim 8 wherein the supports are made of an injection-molded filled plastic.

16. The sensor defined in claim 8 wherein the block is made of an injection-molded filled plastic.
